(19) United States
(12) Patent Application Publication
(10) Pub. No.: US 2005/0138655 A1
(43) Pub. Date: Jun. 23, 2005

(54) Methods, systems and storage medium for managing digital rights of segmented content

(76) Inventors: Randy Zimler, Gainesville, GA (US); William Whited, Atlanta, GA (US)

Correspondence Address: CANTOR COLBURN LLP, 55 Griffin Road South, Bloomfield, CT, 06002, US

(21) Appl. No.: 10/745,423

(22) Filed: Dec. 22, 2003

(51) Int. Cl. H04N 7/173; H04N 7/10; H04N 7/025; H04N 7/16

(52) U.S. Cl. 725/32; 725/135; 725/115; 725/145

(57) ABSTRACT

A method of managing rights associated with content. The method includes receiving a request from a consumer for segmented content. Segments of the segmented content are classified as primary content and secondary content. A segment of primary content is delivered to a consumer along with at least one segment of secondary content. The segment of primary content is divided into portions and portions of the primary content is stored in distributed locations on a storage device. A content map is generated indicating locations of said portions of the primary content.

### FIELD OF THE INVENTION

The present disclosure relates to communications services and in particular to providing content to consumers.

### BACKGROUND

Systems exist for distributing content to users such as broadcast television, cable television, pay-per-view, etc. In such systems, the content provider dictates when content is available and the user may view the content at the scheduled time. Devices such as video cassette recorders (VCRs) and digital video recorders (DVRs), such as the TiVo® system provided by TiVo Inc. of Alviso, Calif., allow users to time-shift content and view the content at a time different from the broadcast time.

With the proliferation of DVDs, consumers have grown accustomed to and enjoy the DVD experience. The ability to skip chapters and jump back and forth between chapters is part of the DVD experience that consumers enjoy. Existing communications systems embodying digital based technologies (DSL, Cable Modems, Digital Terrestrial, etc.) use models such as downloading a file, progressively downloading a file, streaming, or non-managed buffering and playing of multimedia content. None of these techniques provide the DVD experience.

### SUMMARY OF THE INVENTION

Embodiments of the invention include a method of managing rights associated with content. The method includes receiving a request from a consumer for segmented content. Segments of the segmented content are classified as primary content and secondary content. A segment of primary content is delivered to a consumer along with at least one segment of secondary content. The segment of primary content is divided into portions and portions of the primary content is stored in distributed locations on a storage device. A content map is generated indicating locations of said portions of the primary content. Embodiments include a storage medium for implementing the method.

Embodiments of the invention include a system for managing rights associated with content. The system includes a storage device and a controller generating a request for segmented content. The controller classifies segments of the segmented content as primary content and secondary content. A content distribution network includes at least one network element. The network element delivers a segment of primary content to the controller, along with at least one segment of secondary content at a second bandwidth. The controller divides the segment of primary content into portions and stores the portions of the primary content in distributed locations on the storage device. The controller generates a content map indicating locations of the portions of the primary content.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 depicts an exemplary content distribution network in embodiments of the invention.

FIG. 2 depicts an exemplary consumer network in embodiments of the invention.

FIG. 3 is a flowchart of an exemplary process for distributing content in exemplary embodiments of the invention.

FIG. 4 depicts storage of preliminary content in embodiments of the invention.

FIG. 5 depicts storage of primary content in embodiments of the invention.

FIG. 6 depicts storage of primary content and secondary content in embodiments of the invention.

FIG. 7 depicts distributed storage of content in embodiments of the invention.

### DETAILED DESCRIPTION OF THE INVENTION

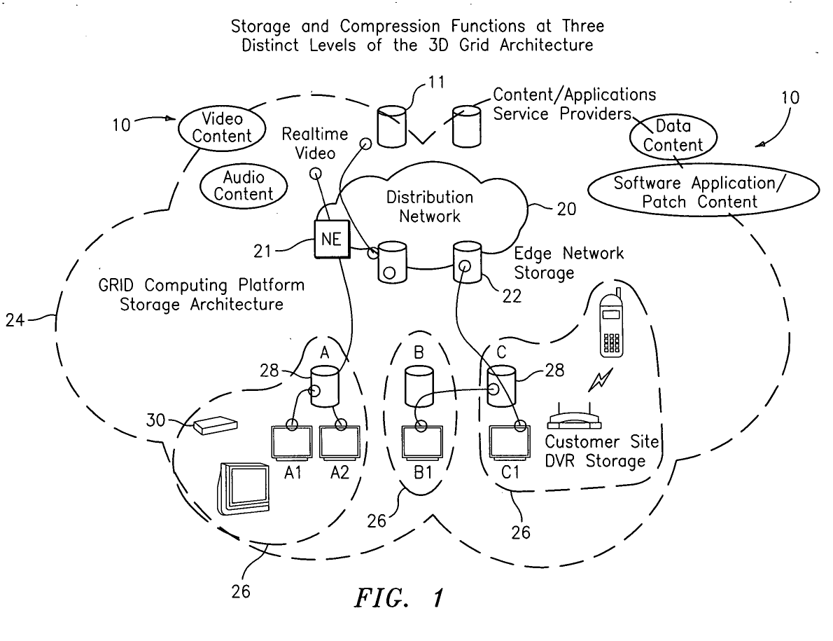

FIG. 1 depicts an exemplary video distribution architecture. The architecture is similar to that disclosed in U.S. patent application Ser. No. 10/605,928, filed Nov. 6, 2003, the entire contents of which are incorporated herein by reference. The video distribution architecture includes the underlying network 20 and software infrastructure to support a video service. The major components of the architecture include the content 10, the distribution network 20 (backbone and access), the network storage 22, the grid computing platform 24, and consumer networks 26. It is understood that the consumer networks 26 are not limited to residential locations but may be any end user of the content.

The content 10 is made available through a distribution agreement between the content distribution system provider and the content owner. The content 10 may be a variety of audio-visual multimedia, such as television programs, movies, audio, consumer-generated content, etc. Consumer-generated content may be stored locally at consumer storage devices 28 (e.g., DVR). There is a defined process for adding new content into the network and an associated profile including digital rights, subscription rules, quality of service (QOS), and billing rules. Content is stored within content provider storage 11, network storage 22 as well as on consumer storage devices (e.g., DVR) at the consumer sites.

The distribution network 20 includes the backbone and the edge network. An MPLS core provides the backbone network for content distribution. The core network interfaces with a variety of access networks and access network technologies. This includes ADSL networks as well as open cable networks, wireless DSL networks, and other access networks as required.

The distributed storage architecture includes storage within the distribution network at content provider storage 11, network storage devices 22, perhaps at a centralized location (e.g., central offices within a telecommunications network, a cable head end) as well as storage devices 28 at the consumers' sites (e.g., DVR devices). The storage network supports transmission of real-time video that is archived for future viewing and supports the transportation of non-real-time video between storage devices (e.g., consumer-to-consumer).

The grid computing platform 24 controls components of the distribution network. The grid computing platform 24 is provided by network elements executing grid applications. As described in further detail herein, the grid computing platform 24 is implemented using processor-based network elements at a central office, at edges of the network, at the consumer location, etc. The processor-based network elements 21 may be implemented using a variety of components such as personal computers, servers, set top boxes, field programmable logic arrays, application specific integrated circuits, etc. This grid applications software controls resources within the network including processing, bandwidth, and storage. The grid computing platform 24 provides the core applications platform for managing content and customer profiles including digital rights, subscriptions, billing, monitoring, etc.

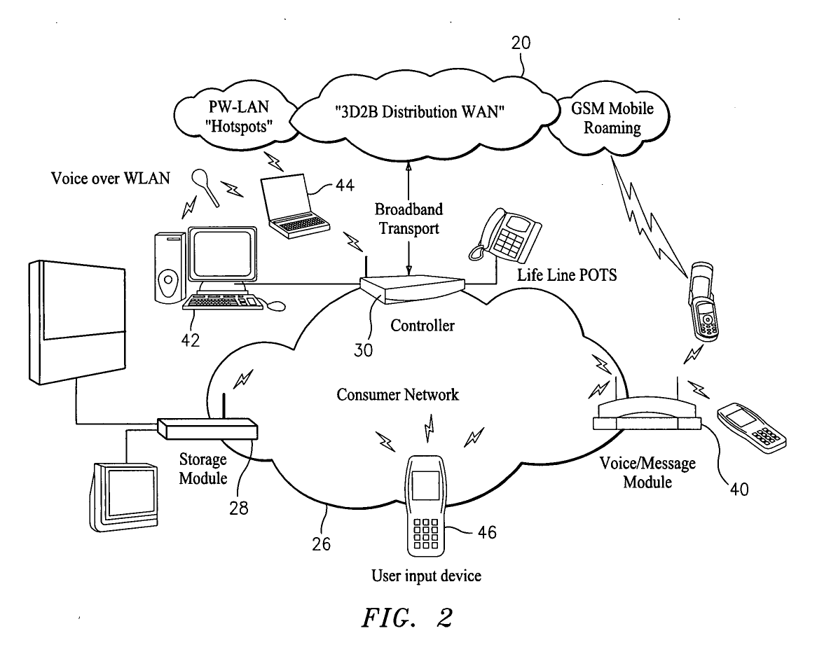

The consumer network 26 is the end user network that seamlessly unites all/any of the typical end-user's information appliances and devices as described in further detail with reference to FIG. 2. The consumer network 26 manages the receipt of content from the distribution network 20 and stores the content on a storage device 28 (e.g., DVR). The consumer network 26 may be based on a wireless networking standard such as 802.11e or wired network architectures such as a LAN.

The distribution network 20 may include any digital packet based network including and not limited to ADSL, open access cable, and/or a wireless DSL platforms. The content distribution service may be offered over another ILEC's ADSL network. The content distribution service could be offered over cable modem access. The service operator derives value from the video service and the video revenue stream, not from the underlying access network. Further, the service platform owner may only need access to the underlying network rather than own the network outright.

The grid computing platform 24 is implemented using distributed network elements such as controller 30 (e.g., set-top box), consumer storage devices 28 (which may be incorporated within controller 30), network storage devices 22 (e.g., at central office, data centers) and/or other network elements (e.g., processors at central office locations or other locations). These processor-based network element(s) determine based on customer preference, customer viewing habits or other reasons when to store a video program on the consumer storage device 28. Processor-based network element(s) decide where to store content that is not resident on the user's local consumer storage device 28. The grid computing platform 24 understands the network relationship between users to optimize network resources when content must be distributed from one consumer's storage device 28 to another consumer's storage device 28.

It is understood that embodiments of the invention are not limited to grid computing platforms. The grid computing platform 24 is provided as an exemplary architecture. Other computing architectures may be used such as a wide area network (WAN) of processor-based network elements.

The grid computing platform 24 manages storage transparently to the consumer. The consumer is aware of the content they currently subscribe to and additional content that they may subscribe to. The location of the content is transparent to the consumer. The consumer does not know and does not need to know if the content is on their local storage device 28 or being pulled from another storage device in the network. In FIG. 1, TV A1 pulls the program out of the resident DVR 28 while TV A2 displays real-time programming streamed over the network 20. TV B1 pulls content from another consumers DVR 28 while TV C1 pulls programming from a network resident storage device 22. Thus, content may be distributed from a variety of storage devices in a distributed network architecture.

FIG. 2 depicts an exemplary consumer network 26 in an embodiment of the invention. In one embodiment, the consumer network 26 is a residential home network, but similar networks may be employed in any setting where content is distributed. The consumer network 26 may be a wireless network that connects multiple devices using existing wireless network techniques (e.g., 802.11g/e/i, 802.11b, HPNA, Power Line Carrier, UWB). The controller 30 is coupled to the distribution network and serves as a gateway device between the consumer network 26 and the distribution network 20.

The consumer network 26 includes associated home devices such as: DVR, TV, PC, PDA, game consoles, telephone, etc. Content may be provided through controller 30 to the consumer's storage device 28 (which may be incorporated within controller 30). A voice/message module 40 provides for wireless telecommunications services. Voice data may also be distributed to a personal computer 42 or laptop 44. Thus, the consumer network 26 provides communication between devices as well as connecting the storage device 28 back to the distribution network 20 for distributing content to other consumers.

The consumer network 26 includes a handheld user input device 46 and associated navigating software to command and control voice, data and video applications. The consumer network 26 has a common control platform for managing devices on the consumer network 26. This includes the ability to navigate through a video programming guide. A simple and functional user interface is one aspect of the content distribution service. This interface promotes watching pre-loaded content thereby reducing the bandwidth across the content distribution network. The interface highlights the breadth of content available on demand to move the consumer away from valuing cable broadcast services based on the number of channels. The consumer selects content through user input device 46. The interface provides advanced flexible features such as pause, rewind, and fast forward that are not provided by the broadcasters without a CPE upgrade. The user input device 46 provides such features to guide the consumer through the program guide.

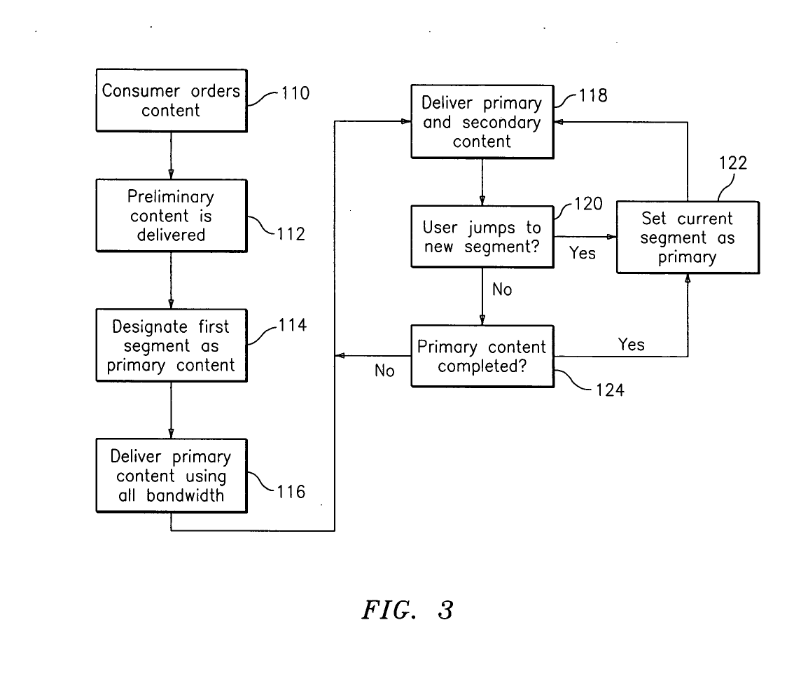

In order to provide segmented content to a consumer and provide the ability jump to different segments, embodiments of the invention manage both bandwidth and storage location of segmented content. FIG. 3 is a flowchart of a process for delivering segmented content to a consumer. The process begins at step 110 when a consumer requests the content. Referring to FIGS. 1 and 2, the controller 30 (e.g., a set top box) is a processor-based network element that executes a computer program to control delivery of content in embodiments of the invention. The controller 30 transmits the request for content to the content distribution network 20. One or more network elements in the content distribution network 20 accesses the content 10 and delivers the content to consumer network 26. Controller 30 indicates which segments of content are needed and indicates the bandwidth to be allocated to each segment as described herein.

At step 112, preliminary content is delivered to the consumer network 26 over the content distribution network 20. The preliminary content includes content ancillary to content requested by the consumer. For example, if the requested content is a movie, the preliminary content includes the FBI warning, movie trailers, advertisements, etc. The preliminary content is provided in a quality lower than or equal to that of primary content so as to consume less bandwidth on the distribution network 20. As the controller 30 receives the preliminary content, it is stored on consumer storage device 28.

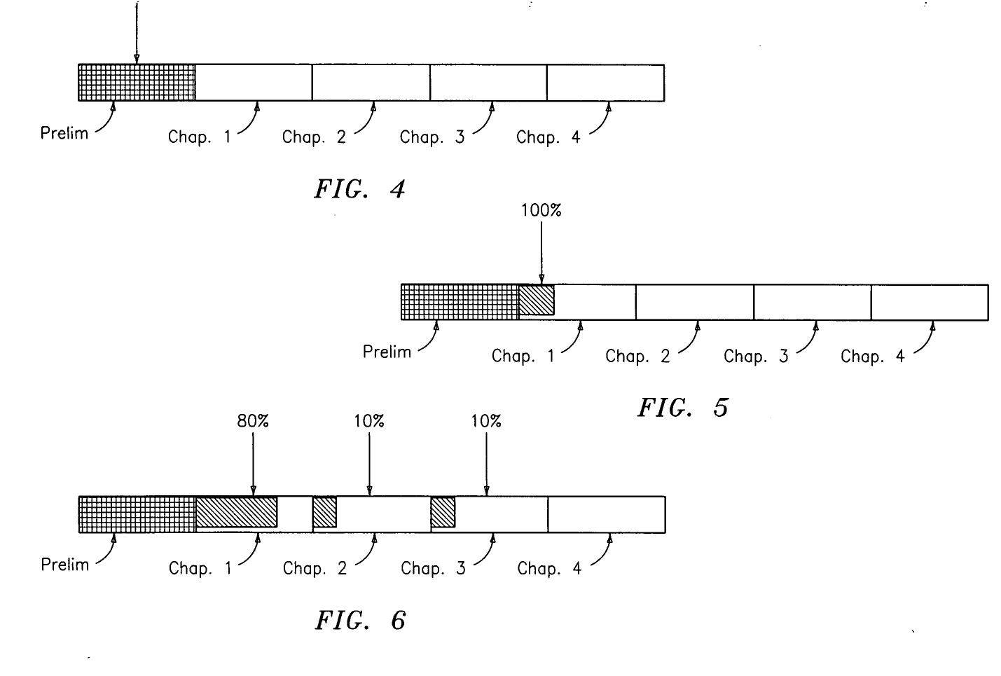

FIG. 4 is a graphical depiction of storage on the consumer storage device 28. As shown in FIG. 4, the preliminary content is delivered initially and stored on consumer storage device 28. Next, segmented content is delivered to the consumer storage device 28 using a distribution mechanism to enable carousel storage of the segmented content. In embodiments of the invention, the segmented content is a movie in a DVD format that contains a number chapters as known in the art. At step 114, the first segment (e.g., first chapter of the movie) is designated the primary content by default by controller 30. At step 116, the primary content is delivered to the consumer storage device 28 using full bandwidth. This begins storing content on the consumer storage device 28. FIG. 5 depicts the delivery of primary content using full bandwidth available to the consumer.

Once a predetermined amount of primary content is stored on the consumer storage device 28, the consumer may begin viewing the content, including the preliminary content that typically cannot be skipped. The predetermined amount of primary content may be based on time, bytes, cells, etc. (e.g., 5 minutes of video). Flow proceeds to step 118 where secondary content is provided concurrently with primary content. In embodiments of the invention, the primary content is the segment that the consumer is currently viewing. The secondary content is one or more other segments identified by controller 30. In embodiments of the invention, the secondary content is one or more segments sequentially following the primary content. In the DVD example, the primary content is initially set to chapter 1 and the secondary content is one or more sequentially following chapters.

Bandwidth is allocated to the delivery of the primary content and secondary content such that the consumer can view the primary content or the consumer can jump to secondary content. In the example shown in FIG. 6, the bandwidth is divided such that 80% of the bandwidth is allocated to the primary content and 20% of the bandwidth is allocated to the secondary content, with 10% allocated to each segment of secondary content. In embodiments of the invention, the bandwidth of the primary content stream is greater than the bandwidth of any one of the secondary content streams.

At step 120, the controller 30 determines if the consumer has jumped to view a new segment of content. This may be determined based on a signal generated by user input device 46. If so, the current segment being viewed is designated as the primary content at step 122 and one or more other following segments are designated secondary content. Flow proceeds to step 118 where the primary and secondary content is delivered using more bandwidth for primary content than secondary content.

If at step 120 the consumer has not jumped to a new segment, flow proceeds to step 124 where it is determined if the primary content segment has been completely loaded on the consumer storage device 28. The user may jump to a new segment using input device 46. If not, flow returns to step 118 where the primary content and secondary content are delivered. If the primary content is completed (e.g., this chapter of the movie is stored on the consumer storage device) then flow proceeds to step 122 where the segment being viewed is set as the primary segment. Flow then proceeds to step 118 where the primary content and secondary content is delivered as described previously.

The processing of FIG. 3 allows a segment being currently viewed to be downloaded using more bandwidth than a secondary content stream. The secondary content is buffered so that if the consumer wishes to jump to another segment, at least the beginning of the segment is available for viewing. Once a new segment is being viewed, the viewed segment is designated the primary segment and allocated additional bandwidth.

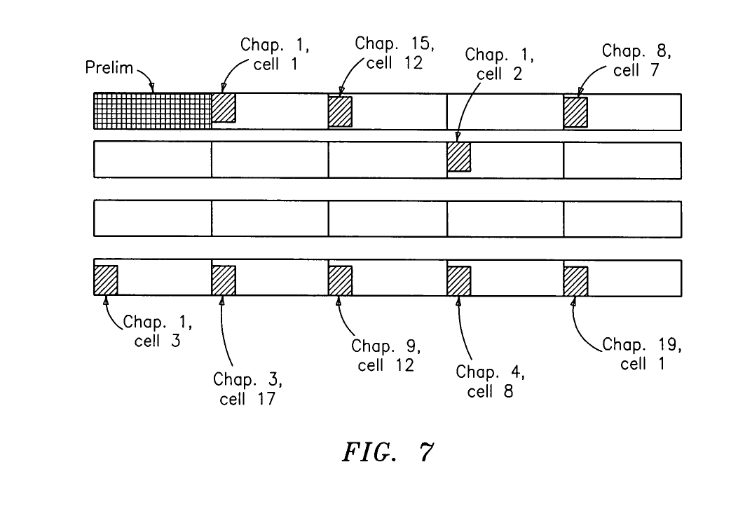

The above described processing manages bandwidth during content delivery so that a consumer can view content in a segmented fashion akin to the DVD experience. The content delivery may also be controlled so as to provide digital rights management. FIG. 7 depicts a technique for preventing unauthorized duplication or distribution of content. Segments of content may be further divided into portions and portions stored in a distributed fashion on consumer storage device 28. The distributed storage of portions of content prevents the consumer from duplicating or distributing the content. A computing algorithm may determine the order in which portions should be reassembled. As described herein, a key to that algorithm is stored in the network by the network service provider and is accessed in real-time. The key is stored in a volatile memory, which cannot be accessed by the user through any available interface.

FIG. 7 depicts exemplary content stored on a consumer storage device 28. In the example shown in FIG. 7, the content is a movie in DVD format divided into segments referred to as chapters which are further divided in portions, referred to as cells. It is understood that the content may be divided in a variety of manners and is not limited to chapter/cell division. Portions of other content formats, or other portions of DVD formatted content, may be diversely distributed across storage device 28.

As cells are received by controller 30, controller 30 executes a distribution algorithm to distribute cells across multiple locations on storage device 28. The algorithm may be a randomization routine that randomly distributes cells. Other routines may be used to distribute cells at varied locations. Embodiments may be based on memory pointers, a mathematical matrix, and disc segmentation may be used to disperse the content on storage device 28. Using a dynamic algorithm and public key security system, an algorithm randomly positions the content on storage device 28. A private key is issued by the content service provider when the user selects the play button on device 46. The private key, valid only for that viewing period, unlocks the position vectors for the content distributed on storage device 28 and reassembles the video for consumption.

Content may be distributed in cylinders based on the number of read/write recording heads associated with a hard drive disc arrangement in storage device 28. Generally, some type of a disc controller such as IDE or SCSI is used to generally manage the position in which data are read/written from/to the hard drive on storage device 28. The format of the drive is optimized to obtain the best possible throughput of digitized video. Standard formatting based on FAT or NTFS are alternatives to a proprietary format.

As the portions of content are stored in a distributed fashion on the consumer storage device 28, the controller 30 records the location of the portions of each segment in a content map. The content map may be stored in memory on controller 30 or on consumer storage device 28. The content map indicates where each portion of each segment of content is stored so that the controller 30 can access the content in the proper order and display the content for the consumer. When the consumer wishes to view the content, controller 30 uses the content map to assemble the content in the proper sequence for viewing.

The content map is copy protected through encryption or encoding so that a consumer cannot access the content map. Accordingly, even if the consumer storage device 28 was duplicated, the content could not be accessed without the content map. A decryption key used to access the content map may have a time limit so that the consumer can only access the content for a limited period of time (e.g., one day).

As described above, embodiments can be embodied in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A method of managing rights associated with content, the method comprising:
receiving a request from a consumer for segmented content;
classifying segments of said segmented content as primary content and secondary content;
delivering to said consumer a segment of primary content along with at least one segment of secondary content;
dividing said segment of primary content into portions;
storing said portions of said primary content in distributed locations on a storage device;
generating a content map indicating locations of said portions of said primary content.

2. The method of claim 1 further comprising:
displaying said content by accessing said content map and retrieving portions of said content in response to said content map.

3. The method of claim 1 wherein:
said content is a movie, said segments corresponding to chapters of said movie, said portions corresponding to cells of said chapters.

4. The method of claim 1 further comprising:
encrypting said content map.

5. The method of claim 1 wherein:
said distributed locations are randomly distributed on said storage device.

6. A system for managing rights associated with content, the system comprising:
a storage device;
a controller generating a request for segmented content, said controller classifying segments of said segmented content as primary content and secondary content;
a content distribution network including at least one network element, said network element delivering to said controller a segment of primary content along with at least one segment of secondary content at a second bandwidth;
said controller dividing said segment of primary content into portions;
said controller storing said portions of said primary content in distributed locations on said storage device;
said controller generating a content map indicating locations of said portions of said primary content.

7. The system of claim 6 wherein:
said controller displays said content by accessing said content map and retrieving portions of said content in response to said content map.

8. The system of claim 6 wherein:
said content is a movie, said segments corresponding to chapters of said movie, said portions corresponding to cells of said chapters.

9. The system of claim 6 wherein:
said controller encrypts said content map.

10. The system of claim 6 wherein:
said distributed locations are randomly distributed on said storage device.

11. A storage medium encoded with machine-readable computer program code for managing rights associated with content, the storage medium including instructions for causing a controller to implement a method comprising:
generating a request for segmented content,
classifying segments of said segmented content as primary content and secondary content;
receiving a segment of primary content along with at least one segment of secondary content;
dividing said segment of primary content into portions;
storing said portions of said primary content in distributed locations on a storage device;
generating a content map indicating locations of said portions of said primary content.
